(19) United States
(12) Patent Application Publication
(10) Pub. No.: US 2015/0163737 A1
(43) Pub. Date: Jun. 11, 2015

(54) METHOD AND DEVICE FOR CONTROLLING TURN-ON AND TURN-OFF OF WIRELESS NETWORK

(71) Applicant: Xiaomi Inc., Beijing (CN)

(72) Inventors: Yuan GAO, Beijing (CN); Bin ZHANG, Beijing (CN); Jinchao LI, Beijing (CN)

(21) Appl. No.: 14/480,787

(22) Filed: Sep. 9, 2014

Related U.S. Application Data
(63) Continuation of application No. PCT/CN2014/077465, filed on May 14, 2014.

(30) Foreign Application Priority Data
Dec. 6, 2013 (CN) 201310656096.2

(51) Int. Cl. H04W 52/02

(52) U.S. Cl. CPC H04W 52/0212

(57) ABSTRACT

A method for controlling turn-on and turn-off of a wireless network, includes: acquiring an operating parameter of a wireless network provided by wireless access equipment; determining whether the operating parameter satisfies a predetermined switching condition; and controlling the wireless access equipment to turn on or turn off the wireless network if it is determined that the operating parameter satisfies the predetermined switching condition.

### CROSS REFERENCE TO RELATED APPLICATIONS

This application is a continuation of International Application No. PCT/CN2014/077465, filed May 14, 2014, which is based upon and claims priority to Chinese Patent Application No. 201310656096.2, filed Dec. 6, 2013, the entire contents of all of which are incorporated herein by reference.

### TECHNICAL FIELD

The present disclosure generally relates to the field of communication technology and, more particularly, to a method and a device for controlling turn-on and turn-off of a wireless network.

### BACKGROUND

With the development of mobile terminals such as smart phones, tablet computers, e-book readers and ultrabooks, wireless local area networks (WLANs) have also been widely applied. In general, the WLAN is set up by adopting wireless fidelity (WiFi).

In a WLAN, a wireless router is often used as wireless access equipment. For ease of use, the wireless access equipment is generally in a turn-on state for a long time. If it is needed to turn off the wireless access equipment, a user needs to manually control a power switch on the wireless access equipment to turn it off. When it is needed to turn on the wireless access equipment again, the user needs to manually control the power switch on the wireless access equipment to turn it on.

When the wireless access equipment is in the turn-on state for a longer time, the wireless access equipment will consume more electrical energy. If the wireless access equipment is turned on/off only by the user's manual operation, the user may need to manually switch on or off the power of the wireless access equipment frequently, which may shorten the lifespan of the wireless access equipment.

### SUMMARY

According to a first aspect of the present disclosure, there is provided a method for controlling turn-on and turn-off ofa wireless network, comprising: acquiring an operating parameter of a wireless network provided by wireless access equipment; determining whether the operating parameter satisfies a predetermined switching condition; and controlling the wireless access equipment to turn on or turn off the wireless network if it is determined that the operating parameter satisfies the predetermined switching condition.

According to a second aspect of the present disclosure, there is provided a device, comprising: a processor; and a memory for storing instructions executable by the processor; wherein the processor is configured to: acquire an operating parameter of a wireless network provided by wireless access equipment; determine whether the operating parameter satisfies a predetermined switching condition; and control the wireless access equipment to turn on or turn off the wireless network if it is determined that the operating parameter satisfies the predetermined switching condition.

According to a third aspect of the present disclosure, there is provided a non-transitory computer-readable storage medium having stored therein instructions that, when executed by a processor of a device, cause the device to perform: acquiring an operating parameter of a wireless network provided by wireless access equipment; determining whether the operating parameter satisfies a predetermined switching condition; and controlling the wireless access equipment to turn on or turn off the wireless network if it is determined that the operating parameter satisfies the predetermined switching condition.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a block diagram of a communication system for controlling turn-on and turn-off of a wireless network, according to an exemplary embodiment.

FIG. 2 is a flowchart of a method for controlling turn-on and turn-off of a wireless network, according to an exemplary embodiment.

FIG. 3 is a flowchart of a method for controlling turn-on and turn-off of a wireless network, according to an exemplary embodiment.

FIG. 4 is a flowchart of a method for controlling turn-on and turn-off of a wireless network, according to an exemplary embodiment.

FIG. 5 is a block diagram of an apparatus for controlling turn-on and turn-off of a wireless network, according to an exemplary embodiment.

FIG. 6 is a block diagram of an apparatus for controlling turn-on and turn-off of a wireless network, according to an exemplary embodiment.

FIG. 7 is a block diagram of a mobile terminal, according to an exemplary embodiment.

FIG. 8 is a block diagram of wireless access equipment, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

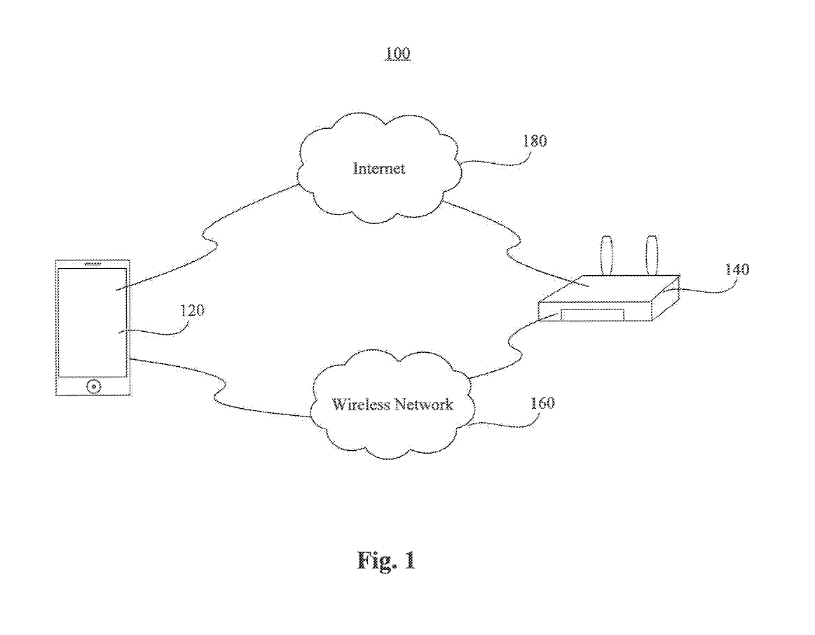

FIG. 1 is a block diagram of a communication system 100 for controlling turn-on and turn-off of a wireless network, according to an exemplary embodiment. Referring to FIG. 1, the communication system 100 includes a mobile terminal 120 and wireless access equipment 140.

The mobile terminal 120 may be a smart phone, a tablet computer, an e-book reader, a moving picture experts group audio layer III (MP3) player, a moving picture experts group audio layer IV (MP4) player, a portable laptop computer, a desktop computer, and so on. The wireless access equipment 140 may be a router or the like.

The mobile terminal 120 and the wireless access equipment 140 may be connected via a wireless network 160 provided by the wireless access equipment 140, or may be connected to other networks such as Internet 180. The mobile terminal 120 and the wireless access equipment 140 can transmit information to each other. When the wireless network 160 provided by the wireless access equipment 140 is turned on, the mobile terminal 120 can communicate directly with the wireless access equipment 140 via the wireless network 160. When the wireless network 160 provided by the wireless access equipment 140 is turned off, the mobile terminal 120 may communicate with the wireless access equipment 140 via other networks, such as the Internet 180 or 2G/3G/4G mobile communication network (not shown), etc.

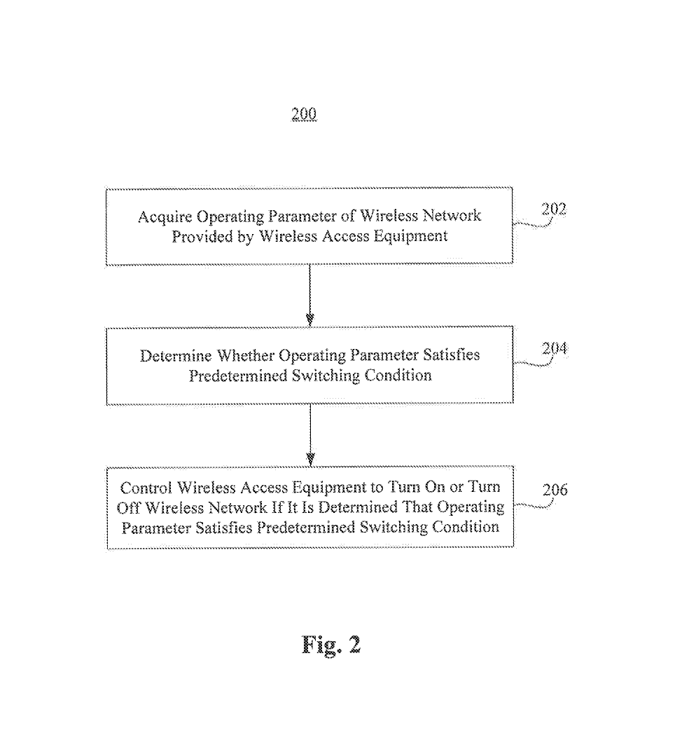

FIG. 2 is a flowchart of a method 200 for controlling turn-on and turn-off of a wireless network, according to an exemplary embodiment. The method 200 may be used in a mobile terminal or wireless access equipment in a communication system, such as the system 100 (FIG. 1). Referring to FIG. 2, the method 200 includes the following steps.

In step 202, an operating parameter of a wireless network provided by the wireless access equipment is acquired.

In step 204, it is determined whether the operating parameter satisfies a predetermined switching condition.

In step 206, the wireless access equipment is controlled to turn on or turn off the wireless network if it is determined that the operating parameter satisfies the predetermined switching condition.

The method 200 can achieve the effects of saving electrical energy, reducing a frequency of manually turning on or turning off the wireless access equipment, reducing operational complexity, and elongating the lifespan of the wireless access equipment.

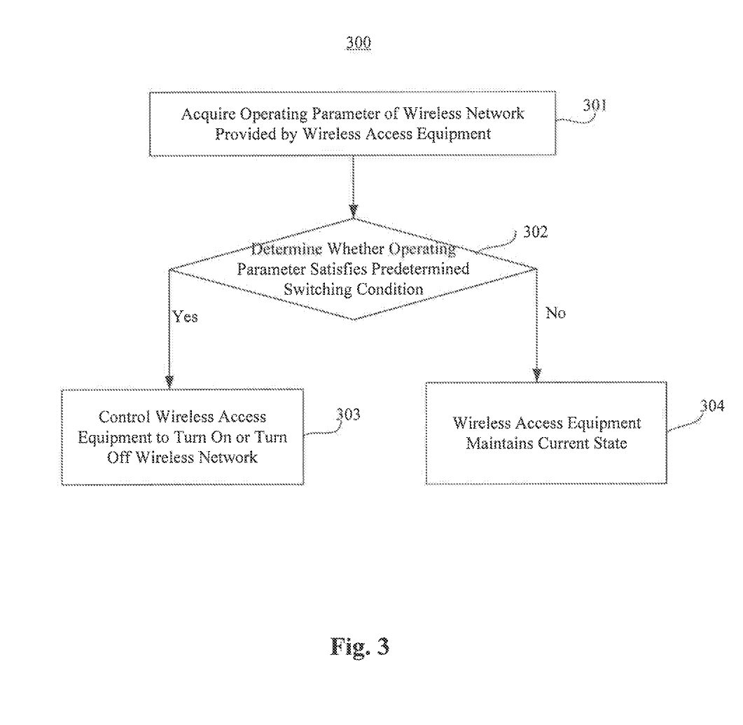

FIG. 3 is a flowchart of a method 300 for controlling turn-on and turn-off of a wireless network, according to an exemplary embodiment. The method 300 may be used in a mobile terminal or wireless access equipment in a communication system, such as the communication system 100 (FIG. 1). Referring to FIG. 3, the method 300 includes the following steps.

In step 301, an operating parameter of a wireless network provided by the wireless access equipment is acquired.

In one exemplary embodiment, the wireless access equipment acquires the operating parameter of the wireless network. The operating parameter of the wireless network includes at least one of a current running time length of the wireless network, a current running time of the wireless network, a current turn-off time of the wireless network, a total amount of data flow of the wireless network within a predetermined time period, a total power consumption value of the wireless network within a predetermined time period, and an instantaneous data flow amount of the wireless network within a predetermined time period.

For example, if the operating parameter of the wireless network is the current running time of the wireless network, the wireless access equipment acquires the current running time of the wireless network through a timing device.

In step 302, it is determined whether the operating parameter satisfies a predetermined switching condition.

In one exemplary embodiment, the wireless access equipment determines whether the operating parameter satisfies the predetermined switching condition. The predetermined switching condition includes a turn-on condition and a turn-off condition.

In exemplary embodiments, the turn-on condition includes one or more of the following conditions: a current turn-off time length of the wireless network reaches a predefined turn-off time length in which the wireless network is turned off, and the current running time of the wireless network is the same as a predefined turn-on time at which the wireless network is scheduled for being turned on.

In exemplary embodiments, the turn-off condition includes one or more of the following conditions: the current running time length of the wireless network reaches a predefined turn-on time length in which the wireless network is turned on, the current running time of the wireless network is the same as a predefined turn-off time at which the wireless network is scheduled for being turned off, the total amount of data flow of the wireless network within a predetermined time period reaches a data flow amount turn-off threshold value, the total power consumption value of the wireless network within a predetermined time period reaches a power consumption turn-off threshold value, and the instantaneous amount of data flow of the wireless network within a predetermined time period is continuously smaller than an instantaneous turn-off threshold value.

In exemplary embodiments, step 302 includes but is not limited to the following cases.

In a first case, the operating parameter is the current running time length of the wireless network. Accordingly, it is determined whether the current running time length reaches the predefined turn-off time length. For example, the predefined turn-off time length is 12 hours.

In a second case, the operating parameter is the current turn-off time length of the wireless network. Accordingly, it is determined whether the current turn-off time length reaches a predefined turn-on time length is determined. For example, the predefined turn-on time length is 6 hours.

In a third case, the operating parameter is the current running time of the wireless network. Accordingly, it is determined whether the current running time is the same as a predefined turn-off time. For example, assuming that the current running time of the wireless network acquired by the timing device is 24 o'clock, it is determined whether the current running time 24 o'clock of the wireless network is the same as a predefined turn-off time in a predefined time list stored in a memory.

In a fourth case, the operating parameter is the current turn-off time of the wireless network. Accordingly, it is determined whether the current turn-off time is the same as a predefined turn-on time. For example, assuming that the current turn-off time of the wireless network acquired by the timing device is 6 o'clock, it is determined whether the current running time 6 o'clock of the wireless network is the same as a predefined turn-on time in a predefined time list stored in the memory.

In a fifth case, the operating parameter is the total amount of data flow of the wireless network within a predetermined time period. Accordingly, it is determined whether the total amount of data flow reaches a data flow amount turn-off threshold value. For example, the data flow amount turn-off threshold value can be set to 200 M data flow in 24 hours.

In a sixth case, the operating parameter is the total power consumption value of the wireless network within a predetermined time period. Accordingly, it is determined whether the total power consumption value reaches a power consumption turn-off threshold. For example, the power consumption turn-off threshold value can be set to 200 W.

In a seventh case, the operating parameter is the instantaneous data flow amount of the wireless network within a predetermined time period. Accordingly, it is determined whether the instantaneous data flow amount is continuously smaller than an instantaneous turn-off threshold value. For example, the instantaneous turn-off threshold value can be set to being continuously smaller than 50 Kbps within 1 hour.

In step 303, the wireless access equipment is controlled to turn on or turn off the wireless network, if it is determined that the operating parameter satisfies the predetermined switching condition.

Step 303 can include but is not limited to the following cases corresponding to the above first through seventh cases.

In the first case, if it is determined that the current running time length of the wireless network reaches the predefined turn-off time length, the wireless access equipment turns off the wireless network.

In the second case, if it is determined that the current turn-off time length of the wireless network reaches the predefined turn-on time length, the wireless access equipment turns on the wireless network.

In the third case, if it is determined that the current running time of the wireless network is the same as the predefined turn-off time, the wireless access equipment turns off the wireless network. For example, assuming that the predefined turn-off time 24 o'clock is in the predefined time list, and the current running time of the wireless network acquired by the timing device is 24 o'clock. When it is determined that the current running time 24 o'clock of the wireless network is the same as the predefined turn-off time 24 o'clock in the predefined time list, the wireless access equipment turns off the wireless network.

In the fourth case, if it is determined that the current running time of the wireless network is the same as the predefined turn-on time, the wireless access equipment turns on the wireless network. For example, it is assumed that the predefined turn-on time 6 o'clock is in the predefined time list, and the current turn-off time of the wireless network acquired by the timing device is 6 o'clock. When it is determined that the current turn-off time 6 o'clock of the wireless network is the same as the predefined turn-on time 6 o'clock in the predefined time list, the wireless access equipment turns on the wireless network.

In the fifth case, if it is determined that the total amount of data flow of the wireless network within a predetermined time period reaches the data flow amount turn-off threshold value, the wireless access equipment turns off the wireless network.

In the sixth case, if it is determined that the total power consumption value of the wireless network within a predetermined time period reaches the power consumption turn-off threshold value, the wireless access equipment turns off the wireless network.

In the seventh case, if it is determined that the instantaneous data flow amount of the wireless network within a predetermined time period is continuously smaller than the instantaneous turn-off threshold value, the wireless access equipment turns off the wireless network.

In exemplary embodiments, when it is determined that the operating parameter satisfies the turn-off condition in the predetermined switching condition, it is also detected whether there is a mobile terminal connected with the wireless access equipment via the wireless network at every predetermined time interval. When it is detected that there is no mobile terminal connected with the wireless access equipment, the wireless access equipment is controlled to turn off the wireless network and to be powered down.

In exemplary embodiments, the turn-off condition includes one or more of the following conditions: the current running time length of the wireless network reaches a predefined turn-off time length, the current running time of the wireless network is the same as a predefined turn-off time, the total amount of data flow of the wireless network within a predetermined time period reaches a flow rate turn-off threshold value, the total power consumption value of the wireless network within a predetermined time period reaches a power consumption turn-off threshold value, and the instantaneous data flow amount of the wireless network within a predetermined time period is continuously smaller than an instantaneous turn-off threshold value.

In step 304, if it is determined that the operating parameter does not satisfy the predetermined switching condition, the wireless access equipment maintains a current state.

The method 300 achieves the effects of saving electrical energy, reducing a frequency of manually turning on or turning off the wireless access equipment, reducing operational complexity, and elongating the lifespan of the wireless access equipment.

In addition, the method 300 detects whether there is a mobile terminal connected with the wireless access equipment through the wireless network at every predetermined time interval, and controls the wireless access equipment to turn off the wireless network and to be powered down when it is detected that there is no mobile terminal connected with the wireless access equipment, thereby achieving the effects of powering down the wireless access equipment when there is no mobile terminal connected with the wireless access equipment, thus saving electric energy and reducing radiation.

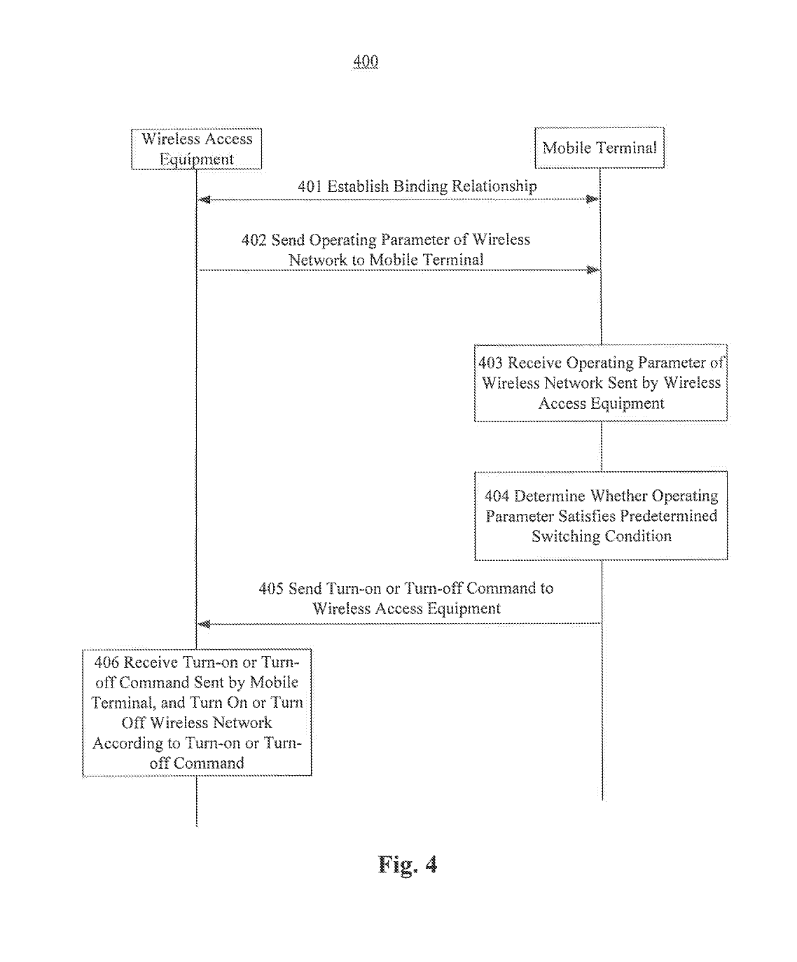

FIG. 4 is a diagram of a method 400 for controlling turn-on and turn-off of a wireless network, according to an exemplary embodiment. Referring to FIG. 4, the method 400 includes the following steps.

In step 401, a binding relationship is established between a mobile terminal and wireless access equipment. The mobile terminal and the wireless access equipment may be bound in advance via a password or other manners, and the mobile terminal stores a name, an IP address, or other information of the wireless access equipment. Information may be transmitted between the mobile terminal and the wireless access equipment via a wireless network provided by the wireless access equipment, or other networks such as the Internet.

In exemplary embodiments, the information transmitted between the mobile terminal and the wireless access equipment may be an operating parameter of the wireless network, or may be a turn-on or turn-off command. When the wireless network is turned on, the mobile terminal can directly communicate with the wireless access equipment via the wireless network. When the wireless network is turned off, the mobile terminal can communicate with the wireless access equipment via other networks. For example, the mobile terminal sends a short message carrying the turn-on or turn-off command to the wireless access equipment via another network.

In step 402, the wireless access equipment sends the operating parameter of the wireless network to the mobile terminal. The operating parameter of the wireless network includes at least one of a current running time length of the wireless network, a current running time of the wireless network, a current turn-off time of the wireless network, a total amount of data flow of the wireless network within a predetermined time period, a total power consumption value of the wireless network within the predetermined time period, and an instantaneous data flow amount of the wireless network within the predetermined time period.

In exemplary embodiments, the wireless access equipment sends the operating parameter of the wireless network to the mobile terminal at each predetermined time interval.

In step 403, the mobile terminal receives the operating parameter of the wireless network sent by the wireless access equipment.

In step 404, the mobile terminal determines whether the operating parameter satisfies a predetermined switching condition. For example, the predetermined switching condition includes a turn-on condition and a turn-off condition.

In exemplary embodiments, the turn-on condition includes one or more of the following conditions: the current turn-off time length of the wireless network reaches a predefined turn-off time length in which the wireless network is turned off, and the current running time of the wireless network is the same as a predefined turn-on time at which the wireless network is scheduled for being turned on.

In exemplary embodiments, the turn-off condition includes one or more of the following conditions: the current running time length of the wireless network reaches a predefined turn-on time length in which the wireless network is turned on, the current running time of the wireless network is the same as a predefined turn-off time at which the wireless network is scheduled for being turned off, the total amount of data flow of the wireless network within a predetermined time period reaches a flow rate turn-off threshold value, the total power consumption value of the wireless network within a predetermined time period reaches a power consumption turn-off threshold value, and the instantaneous data flow amount of the wireless network within a predetermined time period is continuously smaller than an instantaneous turn-off threshold value.

Step 404 may include but is not limited to the following cases.

In a first case, the operating parameter is the current running time length of the wireless network. Accordingly, the mobile terminal determines whether the current running time length reaches a predefined turn-off time length. For example, the predefined turn-off time length is 12 hours.

In a second case, the operating parameter is the current turn-off time length of the wireless network. Accordingly, the mobile terminal determines whether the current turn-off time length reaches a predefined turn-on time length. For example, the predefined turn-on time length is 6 hours.

In a third case, the operating parameter is the current running time of the wireless network. Accordingly, the mobile terminal determines whether the current running time is the same as a predefined turn-off time. For example, assuming that the current running time of the wireless network acquired by a timing device of the wireless access equipment is 24 o'clock, the mobile terminal determines whether the current running time 24 o'clock of the wireless network is the same as a predefined turn-off time in a predefined time list stored in a memory of the mobile terminal.

In a fourth case, the operating parameter is the current turn-off time of the wireless network. Accordingly, the mobile terminal determines whether the current turn-off time is the same as a predefined turn-on time. For example, assuming that the current running time of the wireless network acquired by the timing device of the wireless access equipment is 6 o'clock, the mobile terminal determines whether the current running time 6 o'clock of the wireless network is the same as a predefined turn-on time in a predefined time list stored in the memory.

In a fifth case, the operating parameter is the total amount of data flow of the wireless network within a predetermined time period. Accordingly, the mobile terminal determines whether the total amount of data flow reaches a data flow amount turn-off threshold value. For example, the data flow amount turn-off threshold value can be set to 200 M data flow in 24 hours.

In a sixth case, the operating parameter is the total power consumption value of the wireless network within a predetermined time period. Accordingly, the mobile terminal determines whether the total power consumption value reaches a power consumption turn-off threshold value. For example, the power consumption turn-off threshold value can be set to 200 W.

In a seventh case, the operating parameter is the instantaneous data flow amount of the wireless network within a predetermined time period. Accordingly, the mobile terminal determines whether the instantaneous data flow amount is continuously smaller than an instantaneous turn-off threshold value. For example, the instantaneous turn-off threshold value can be set being continuously smaller than 50 Kbps within 1 hour.

In step 405, the mobile terminal sends a turn-on or turn-off command to the wireless access equipment. The turn-on command is configured to trigger the wireless access equipment to turn on the wireless network, and the turn-off command is configured to trigger the wireless access equipment to turn off the wireless network. When the wireless network provided by the wireless access equipment is turned on, the mobile terminal directly sends the turn-off command to the wireless access equipment via the wireless network; and when the wireless network provided by the wireless access equipment is turned off, the mobile terminal sends the turn-on command to the wireless access equipment via a network other than the wireless network.

Step 405 can include but is not limited to the cases corresponding to the above first through seventh cases.

In the first case, if it is determined that the current running time length of the wireless network reaches the predefined turn-off time length, the mobile terminal sends the turn-off command to the wireless access equipment.

In the second case, if it is determined that the current turn-off time length of the wireless network reaches the predefined turn-on time length, the mobile terminal sends the turn-on command to the wireless access equipment.

In the third case, if it is determined that the current running time of the wireless network is the same as the predefined turn-off time, the mobile terminal sends the turn-off command to the wireless access equipment. For example, it is assumed that the predefined turn-off time 24 o'clock is in the predefined time list, and the current running time of the wireless network acquired by the timing device is 24 o'clock. When it is determined that the current running time 24 o'clock of the wireless network is the same as the predefined turn-off time 24 o'clock in the predefined time list, the mobile terminal sends the turn-off command to the wireless access equipment.

In the fourth case, if it is determined that the current running time of the wireless network is the same as the predefined turn-on time, the mobile terminal sends the turn-on command to the wireless access equipment. For example, it is assumed that the predefined turn-on time 6 o'clock is in the predefined time list, and the current running time of the wireless network acquired by the timing device is 6 o'clock. When it is determined that the current running time 6 o'clock of the wireless network is the same as the predefined turn-on time 6 o'clock in the predefined time list, the mobile terminal sends the turn-on command to the wireless access equipment.

In the fifth case, if it is determined that the total amount of data flow of the wireless network within a predetermined time period reaches the data flow amount turn-off threshold value, the mobile terminal sends the turn-off command to the wireless access equipment.

In the sixth case, if it is determined that the total power consumption value of the wireless network within a predetermined time period reaches the power consumption turn-off threshold value, the mobile terminal sends the turn-off command to the wireless access equipment.

In the seventh case, if it is determined that the instantaneous data flow amount of the wireless network within a predetermined time period is continuously smaller than the instantaneous turn-off threshold value, the mobile terminal sends the turn-off command to the wireless access equipment.

In step 406, the wireless access equipment receives the turn-on command or the turn-off command sent by the mobile terminal, and turns on or turns off the wireless network according to the turn-on command or turn-off command.

In exemplary embodiments, when it is determined that the operating parameter satisfies the turn-off condition in the predetermined switching condition, it is also detected whether there is a mobile terminal connected with the wireless access equipment through the wireless network at every predetermined time interval. When it is detected that there is no mobile terminal connected with the wireless access equipment, the wireless access equipment is controlled to turn off the wireless network and to be powered down.

In exemplary embodiments, the turn-off condition includes one or more of the following conditions: the current running time length of the wireless network reaches a predefined turn-off time length, the current running time of the wireless network is the same as a predefined turn-off time, the total amount of data flow of the wireless network within a predetermined time period reaches a flow rate turn-off threshold value, the total power consumption value of the wireless network within a predetermined time period reaches a power consumption turn-off threshold value, and the instantaneous data flow amount of the wireless network within a predetermined time period is continuously smaller than an instantaneous turn-off threshold value.

The method 400 achieves the effects of controlling the wireless access equipment to turn on or turn off the wireless network by the mobile terminal, thus reducing a frequency of manually turning on or turning off the power of the wireless access equipment, reducing operational complexity, elongating the lifespan of the wireless access equipment, and saving electrical energy.

In addition, the method 400 detects whether there is a mobile terminal connected with the wireless access equipment through the wireless network at every predetermined time interval, and controls the wireless access equipment to turn off the wireless network and to be powered down when it is detected that there is no mobile terminal connected with the wireless access equipment, thereby achieving the effects of powering down the wireless access equipment when there is no mobile terminal connected with the wireless access equipment, thus saving electric energy and reducing radiation.

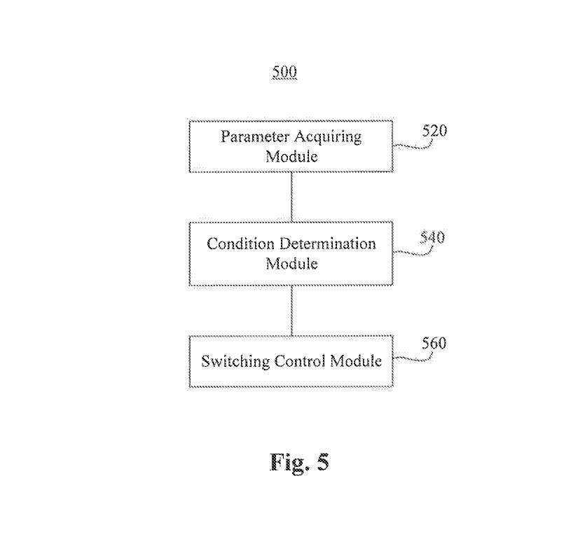

FIG. 5 is a block diagram of an apparatus 500 for controlling turn-on and turn-off of a wireless network, according to an exemplary embodiment. Referring to FIG. 5, the apparatus 500 may constitute all or a part of a mobile terminal or the wireless access equipment by software, hardware, or a combination thereof. The apparatus 500 includes a parameter acquiring module 520, a condition determination module 540, and a switching control module 560.

The parameter acquiring module 520 is configured to acquire an operating parameter of a wireless network provided by the wireless access equipment.

The condition determination module 540 is configured to determine whether the operating parameter acquired by the parameter acquiring module 520 satisfies a predetermined switching condition.

The switching control module 560 is configured to control the wireless access equipment to turn on or turn off the wireless network if the condition determination module 540 determines that the operating parameter satisfies the predetermined switching condition.

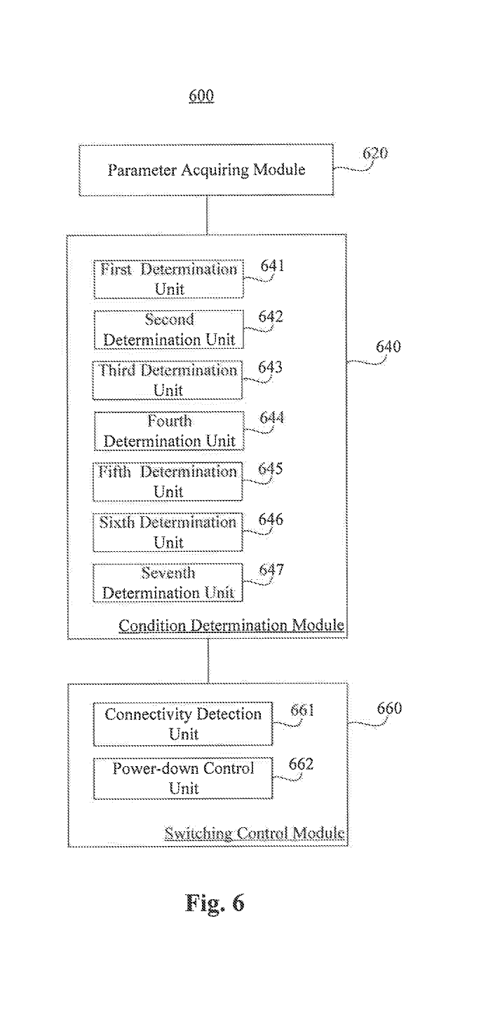

FIG. 6 is a block diagram of an apparatus 600 for controlling turn-on and turn-off of a wireless network, according to an exemplary embodiment. Referring to FIG. 6, the apparatus 600 may constitute all or a part of a mobile terminal or wireless access equipment by software, hardware, or a combination thereof. The apparatus 600 includes a parameter acquiring module 620, a condition determination module 640, and a switching control module 660.

The parameter acquiring module 620 is configured to acquire an operating parameter of a wireless network provided by the wireless access equipment.

The condition determination module 640 is configured to determine whether the operating parameter acquired by the parameter acquiring module 620 satisfies a predetermined switching condition.

The switching control module 660 is configured to control the wireless access equipment to turn on or turn off the wireless network if the condition determination module 640 determines that the operating parameter satisfies the predetermined switching condition.

The condition determination module 640 includes one or more of a first determination unit 641, a second determination unit 642, a third determination unit 643, a fourth determination unit 644, a fifth determination unit 645, a sixth determination unit 646, and a seventh determination unit 647.

The first determination unit 641 is configured to determine whether a current running time length of the wireless network reaches a predefined turn-off time length, if the operating parameter is the current running time length.

The second determination unit 642 is configured to determine whether a current turn-off time length of the wireless network reaches a predefined turn-on time length, if the operating parameter is the current turn-off time length.

The third determination unit 643 is configured to determine whether a current running time of the wireless network is the same as a predefined turn-off time, if the operating parameter is the current running time.

The fourth determination unit 644 is configured to determine whether a current turn-off time of the wireless network is the same as a predefined turn-on time, if the operating parameter is the current turn-off time.

The fifth determination unit 645 is configured to determine whether a total amount of data flow of the wireless network within a predetermined time period reaches a data flow amount turn-off threshold value, if the operating parameter is the total amount of data flow.

The sixth determination unit 646 is configured to determine whether a total power consumption value of the wireless network within a predetermined time period reaches a power consumption turn-off threshold value, if the operating parameter is the total power consumption value.

The seventh determination unit 647 is configured to determine whether an instantaneous data flow amount of the wireless network within a predetermined time period is continuously smaller than an instantaneous turn-off threshold value, if the operating parameter is the instantaneous data flow amount.

The switching control module 660 includes a connectivity detection unit 661 and a power-down control unit 662.

The connectivity detection unit 661 is configured to detect whether there is a mobile terminal connected with the wireless access equipment via the wireless network at every predetermined time interval, when it is determined that the operating parameter satisfies the turn-off condition in the predetermined switching condition.

The power-down control unit 662 is configured to control the wireless access equipment to turn off the wireless network and to be powered down, when it is detected that there is no mobile terminal connected with the wireless access equipment.

If the apparatus 600 is used in the mobile terminal, the parameter acquiring module 620 is configured to receive the operating parameter of the wireless network sent by the wireless access equipment, and the switching control module 660 is configured to send a turn-on command or a turn-off command to the wireless access equipment, wherein the turn-on command is configured to trigger the wireless access equipment to turn on the wireless network, and the turn-off command is configured to trigger the wireless access equipment to turn off the wireless network.

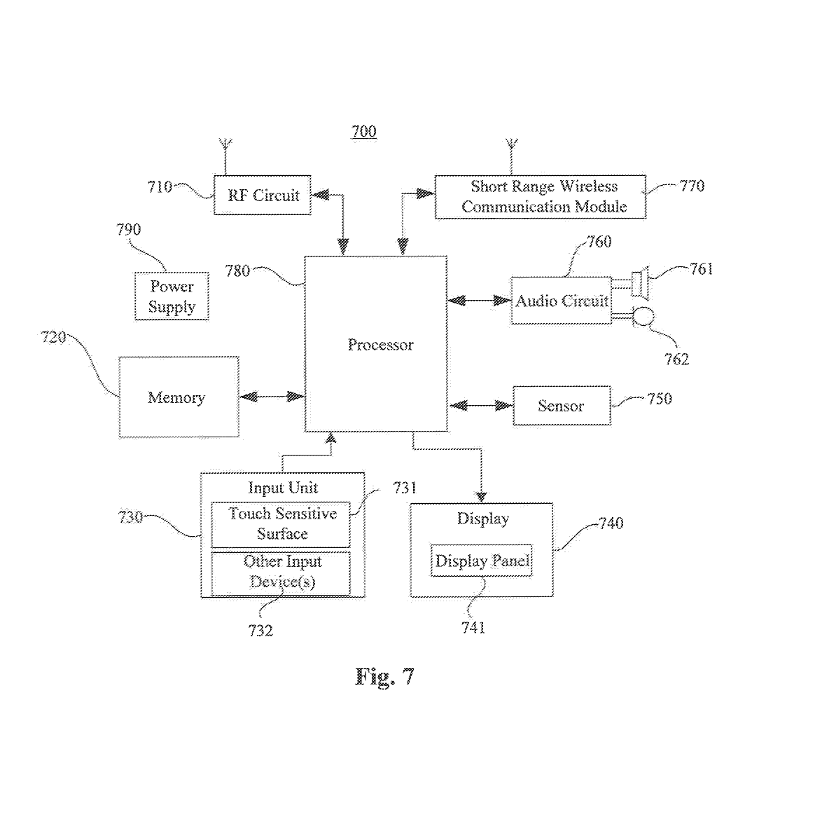

FIG. 7 is a block diagram of a mobile terminal 700, according to an exemplary embodiment. The mobile terminal 700 is configured to perform any of the above described method for controlling turn-on and turn-off of a wireless network. Referring to FIG. 7, the mobile terminal 700 may include one or more of a radio frequency (RF) circuit 710, memory resources represented by a memory 720, an input unit 730, a display 740, a sensor 750, an audio circuit 760, a short range wireless communication module 770, a processor 780 including one or more processing cores, and a power supply 790. It should be appreciated by those skilled in the art that the structure shown in FIG. 7 does not constitute a limitation to the mobile terminal 700, and the mobile terminal 700 may include more or less components than those shown in FIG. 7, or a combination of some of the components, or have different component arrangements.

The RF circuit 710 is configured to transmit and receive signals during transmitting and receiving information or a call procedure. For example, the RF circuit 710 receives downlink information from a base station, and then sends the downlink information to the processors 780 to be processed. Also, the RF circuit 710 transmits uplink data to the base station. Generally, the RF circuit 710 includes, but is not limited to, an antenna, at least one amplifier, a tuner, one or more oscillators, a subscriber identity module (SIM) card, a transceiver, a coupler, a low noise amplifier (LNA), a duplexer, etc. Furthermore, the RF circuit 710 may communicate with a network and other apparatuses through wireless communication using any communication standards or protocols, including but not limited to global system of mobile communication (GSM), general packet radio service (GPRS), code division multiple access (CDMA), wideband code division multiple access (WCDMA), long term evolution (LTE), e-mail, short messaging service (SMS), etc.

The memory 720 is configured to store software programs and modules. The processor 780 performs various functional applications and data processing by running the software programs and modules stored in the memory 720. The memory 720 may mainly include a program storage area and a data storage area. The program storage area may store an operating system, application programs required by at least one function (such as a function of sound playback, a function of image playback, etc.). The data storage area may store data created during operation of the mobile terminal 700 (such as audio data, phone book, etc.). In addition, the memory 720 may include a high-speed random access memory, and may also include a non-volatile memory, such as at least one disk storage device, a flash memory device, or other non-volatile solid-state memory devices. Accordingly, the memory 720 may also include a memory controller to provide access to the memory 720 performed by the processor 780 and the input unit 730.

The input unit 730 is configured to receive information of input numbers or characters, and generate signal inputs from a keyboard, a mouse, a joystick, an optical device, or a trackball related to a user setting and functional control. The input unit 730 may include a touch sensitive surface 731 and one or more other input devices 732. The touch sensitive surface 731, also known as a touch screen or a track pad, may collect the user's touch operations on or near the touch sensitive surface 731 (such as an operation performed by the user using any suitable object or accessory such as a finger, a touch pen and the like on or near the touch sensitive surface 731), and drive a corresponding connected device according to a preset program. For example, the touch sensitive surface 731 may include first and second parts, i.e., a touch detection device and a touch controller. The touch detection device detects a touching operation of the user and a signal caused by the touch operation, and transmits the signal to the touch controller. The touch controller receives touch information from the touch detection device, transforms it into coordinates of the touch position, and sends the coordinates to the processor 780. The touch controller may also receive a command from the processor 780 and execute the command. In addition, the touch sensitive surface 731 may be realized in various types, such as a resistive type, a capacitive type, an infrared type, or a surface acoustic wave type. In addition to the touch sensitive surface 731, the input unit 730 may also include one or more other input devices 732. For example, the other input devices 732 may include, but are not limited to, one or more of a physical keyboard, a functional key (such as a volume control key, a switch button), a trackball, a mouse, and a joystick.

The display unit 740 is configured to display information input by the user or information provided to the user and various graphical user interfaces of the mobile terminal 700. These graphical user interfaces may consist of graphics, texts, source display frames, videos, and any combination thereof. The display 740 may include a display panel 741. The display panel 741 may be configured with a liquid crystal display (LCD), an organic light-emitting diode (OLED), etc. Further, the touch sensitive surface 731 may cover the display panel 741. When a touch operation on or near the touch sensitive surface 731 is detected by the touch sensitive surface 731, the touch operation is sent to the processor 780 to determine the type of the touch operation, and then a corresponding visual output will be provided on the display panel 741 by the processor 780 according to the type of touch operation. Although in FIG. 7 the touch sensitive surface 731 and the display panel 741 are two separate components to realize input and output functions, in some embodiments, the touch sensitive surface 731 and the display panel 741 may be integrated to realize input and output functions.

The sensor 750 may be a light sensor, a motion sensor, or any other sensors. The light sensor may include an ambient light sensor and a proximity sensor. The ambient light sensor may adjust a brightness of the display panel 741 according to a brightness of the ambient light. The proximity sensor may turn off the display panel 741 and/or backlight when the mobile terminal 700 moves close to the user's ear. As an example of the motion sensor, a gravity acceleration sensor may detect a magnitude of an acceleration in each of one or more directions (such as along three axes), and may detect a magnitude and a direction of the gravity when it is stationary. The gravity acceleration sensor may be used in applications for identifying an attitude of the mobile terminal 700 (such as horizontal and vertical screen switching, related games, attitude calibration of a magnetometer), functions related to vibration recognizing (such as a pedometer, clicking), etc. The mobile terminal 700 may also be equipped with other sensors such as a gyroscope, a barometer, a hygrometer, a thermometer, an infrared sensor, etc.

The audio circuit 760 is coupled to a speaker 761 and a microphone 762, and may provide an audio interface between the user and the mobile terminal 700. The audio circuit 760 may transform received audio data into electrical signals, which are transmitted to the speaker 761 and transformed into sound signals to be output by the speaker 761. On the other hand, the microphone 762 transforms collected sound signals into electrical signals, which are received and transformed into audio data by the audio circuit 760. After being output to the processor 780 to be processed, the audio data is transmitted to, for example, another terminal via the RF circuit 710, or output to the memory 720 for further processing. The audio circuit 760 may also include an earplug jack to allow a communication between an external earphone and the mobile terminal 700.

The short range wireless communication module 770 may be a WiFi module configured to provide the user with a wireless broadband Internet access, which allows the user to send and receive emails, browse webpages, and access streaming media, etc. Although FIG. 7 shows the short range wireless communication module 770, it should be understood that the short range wireless communication module 770 is not a necessary component of the mobile terminal 700, and may be omitted as desired.

The processor 780 is a control center of the mobile terminal 700 that connects various parts of the mobile terminal 700 through various interfaces and circuits, and performs various functions and data processing by executing the software programs and/or modules stored in the memory 720 and by invoking data stored in the memory 720. For example, the processor 780 may include one or more processing cores. The processor 780 may be integrated with an application processor that mainly processes the operating system, user interfaces and application programs, and a modem processor that mainly processes wireless communication. In some embodiments, the modem processor may not be integrated into the processor 780.

The power supply 790 is configured to supply power to components of the mobile terminal 700. The power supply 790 may be logically connected to the processor 780 through a power supply management system, so as to achieve the functions such as charging, discharging, and power consumption management through the power supply management system. The power supply 790 may also include one or more components of a direct current (DC) or alternating current (AC) power, a recharge system, a power failure detection circuit, a power converter or an inverter, a power status indicator, etc.

Although not shown, the mobile terminal 700 may also include a camera, a Bluetooth module, etc.

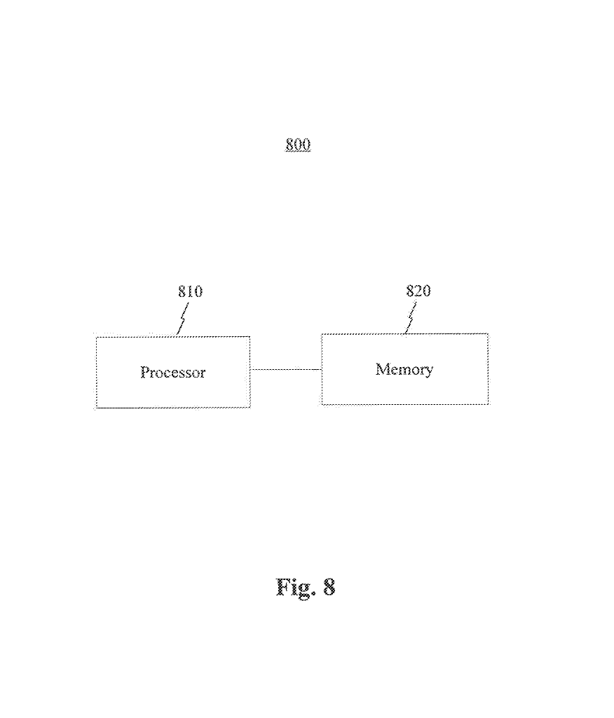

FIG. 8 is a block diagram of wireless access equipment 800, according to an exemplary embodiment. For example, the wireless access equipment 800 may be a wireless router. Referring to FIG. 8, the wireless access equipment 800 includes a processor 810 and a memory 820 for storing data as well as for storing program instructions, e.g., for performing the above-described methods for controlling turn-on and turn-off of a wireless network, and otherwise facilitating operation of the processor 810.

In exemplary embodiments, there is also provided a non-transitory computer readable storage medium including instructions, such as included in the memory 720 (FIG. 7) or 820 (FIG. 8), executable by the processor 780 (FIG. 7) or 810 (FIG. 8), for performing the above-described methods for controlling turn-on and turn-off of a wireless network. For example, the storage medium may be a compact disc (CD), a laser disc, an optical disc, a digital versatile disc (DVD), a floppy disc, a blu-ray disc, a read-only memory (ROM), a programmable ROM (PROM), an electrically programmable ROM (EPROM), an electrically erasable programmable ROM (EEPROM), a flash memory, a random access memory (RAM) which can act as an external cache memory. As an example and not restrictive, RAM may be obtained in various forms, such as a synchronous RAM (DRAM), a dynamic RAM (DRAM), a synchronous DRAM (SDRAM), a double data rate SDRAM (DDR SDRAM), an enhanced SDRAM (ESDRAM), a synchronization link DRAM (SLDRAM), and a direct RambusRAM (DRRAM). The storage medium of the present disclosure is intended to include any suitable types of storage.

Various illustrative logical blocks, modules and circuits described in combination with the contents disclosed herein may be realized or executed by the following components which are designed for executing the above functions: a general purpose processor, a digital signal processor (DSP), an application specific integrate circuit (ASIC), a field programmable gate array (FPGA), or other programmable logic devices, a discrete gate, or a transistor logic, a discrete hardware element or any combination thereof. The general purpose processor may be a microprocessor. Alternatively, the processor may be any conventional processor, controller, microcontroller or state machine. The processor may also be implemented as a combination of the computing devices, such as a combination of a DSP and a microprocessor, a plurality of microprocessors, one or more microprocessor combined with a DSP core, or any other such configurations.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling turn-on and turn-off of a wireless network, comprising:
acquiring an operating parameter of a wireless network provided by wireless access equipment;
determining whether the operating parameter satisfies a predetermined switching condition; and
controlling the wireless access equipment to turn on or turn off the wireless network if it is determined that the operating parameter satisfies the predetermined switching condition.

2. The method according to claim 1, wherein when the operating parameter is a current running time length of the wireless network, the determining of whether the operating parameter satisfies the predetermined switching condition comprises:
determining whether the current running time length of the wireless network reaches a predefined turn-on time length.

3. The method according to claim 1, wherein when the operating parameter is a current turn-off time length of the wireless network, the determining of whether the operating parameter satisfies the predetermined switching condition comprises:
determining whether the current turn-off time length of the wireless network reaches a predefined turn-off time length.

4. The method according to claim 1, wherein when the operating parameter is a current running time of the wireless network, the determining of whether the operating parameter satisfies the predetermined switching condition comprises:
determining whether the current running time of the wireless network is the same as a predefined turn-off time.

5. The method according to claim 1, wherein when the operating parameter is a current running time of the wireless network, the determining of whether the operating parameter satisfies the predetermined switching condition comprises:
determining whether the current running time of the wireless network is the same as a predefined turn-on time.

6. The method according to claim 1, wherein when the operating parameter is a total amount of data flow of the wireless network within a predetermined time period, the determining of whether the operating parameter satisfies the predetermined switching condition comprises:
determining whether the total amount of data flow of the wireless network within the predetermined time period reaches a data flow amount turn-off threshold value.

7. The method according to claim 1, wherein when the operating parameter is a total power consumption value within a predetermined time period, the determining of whether the operating parameter satisfies the predetermined switching condition comprises:
determining whether the total power consumption value of the wireless network within the predetermined time period reaches a power consumption turn-off threshold value.

8. The method according to claim 1, wherein when the operating parameter is an instantaneous data flow amount of the wireless network within a predetermined time period, the determining of whether the operating parameter satisfies the predetermined switching condition comprises:
determining whether the instantaneous data flow amount of the wireless network within the predetermined time period is continuously smaller than an instantaneous turn-off threshold value.

9. The method according to claim 1, wherein the controlling of the wireless access equipment to turn off the wireless network comprises:
detecting whether there is a mobile terminal connected with the wireless access equipment via the wireless network at every predetermined time interval, when it is determined that the operating parameter satisfies a turn-off condition in the predetermined switching condition; and
controlling the wireless access equipment to turn off the wireless network and to power down, when it is detected that there is no mobile terminal connected with the wireless access equipment.

10. The method according to claim 1, wherein the acquiring of the operating parameter of the wireless network provided by the wireless access equipment comprises:
receiving, by a mobile terminal, the operating parameter of the wireless network sent by the wireless access equipment.

11. The method according to claim 1, wherein the controlling of the wireless access equipment to turn on or turn off the wireless network comprises:
sending, by a mobile terminal, one of a turn-on command or a turn-off command to the wireless access equipment, the turn-on command being configured to trigger the wireless access equipment to turn on the wireless network, and the turn-off command being configured to trigger the wireless access equipment to turn off the wireless network.

12. A device, comprising:
a processor; and
a memory for storing instructions executable by the processor;
wherein the processor is configured to:
acquire an operating parameter of a wireless network provided by wireless access equipment;
determine whether the operating parameter satisfies a predetermined switching condition; and
control the wireless access equipment to turn on or turn off the wireless network if it is determined that the operating parameter satisfies the predetermined switching condition.

13. The device according to claim 12, wherein the processor is further configured to perform at least one of:
determining whether a current running time length of the wireless network reaches a predefined turn-on time length, if the operating parameter is the current running time length;
determining whether a current turn-off time length of the wireless network reaches a predefined turn-off time length, if the operating parameter is the current turn-off time length;
determining whether a current running time of the wireless network is the same as a predefined turn-off time or a predefined turn-on time, if the operating parameter is the current running time;
determining whether a total amount of data flow of the wireless network within a predetermined time period reaches a data flow amount turn-off threshold value, if the operating parameter is the total amount of data flow;
determining whether a total power consumption value of the wireless network within a predetermined time period reaches a power consumption turn-off threshold value, if the operating parameter is the total power consumption value; and
determining whether an instantaneous data flow amount of the wireless network within a predetermined time period is continuously smaller than an instantaneous turn-off threshold value, if the operating parameter is the instantaneous data flow amount.

14. The device according to claim 12, being the wireless access equipment, wherein the processor is further configured to:
detect whether there is a mobile terminal connected with the wireless access equipment via the wireless network at every predetermined time interval, when it is determined that the operating parameter satisfies a turn-off condition in the predetermined switching condition; and
control the wireless access equipment to turn off the wireless network and to power down, when it is detected that there is no mobile terminal connected with the wireless access equipment.

15. The device according to claim 12, being a mobile terminal, wherein the processor is further configured to:
receive the operating parameter of the wireless network sent by the wireless access equipment.

16. The device according to claim 12, being a mobile terminal, wherein the processor is further configured to:
send one of a turn-on command or a turn-off command to the wireless access equipment, the turn-on command being configured to trigger the wireless access equipment to turn on the wireless network, and the turn-off command being configured to trigger the wireless access equipment to turn off the wireless network.

17. A non-transitory computer-readable storage medium having stored therein instructions that, when executed by a processor of a device, cause the device to perform:
acquiring an operating parameter of a wireless network provided by wireless access equipment;
determining whether the operating parameter satisfies a predetermined switching condition; and
controlling the wireless access equipment to turn on or turn off the wireless network if it is determined that the operating parameter satisfies the predetermined switching condition.
